(19) United States
(12) Patent Application Publication
(10) Pub. No.: US 2009/0075125 A1
(43) Pub. Date: Mar. 19, 2009

(54) Dot pattern contact layer

(75) Inventors: Matthias Gottmann, Sunnyvale, CA (US); Patrick Munoz, Milpitas, CA (US)

Correspondence Address: FOLEY AND LARDNER LLP;SUITE 500, 3000 K STREET NW, WASHINGTON, DC, 20007, US

(73) Assignee: BLOOM ENERGY CORPORATION

(21) Appl. No.: 12/213,088

(22) Filed: Jun. 13, 2008

Related U.S. Application Data
(60) Provisional application No. 60/929,161, filed on Jun. 15, 2007.

(51) Int. Cl. H01M 8/02; H01M 4/04

(52) U.S. Cl. 429/12; 427/115; 156/276; 156/89.16

(57) ABSTRACT

A fuel cell comprises a first electrode, a second electrode, an electrolyte, and an electrically conductive first dot pattern contact layer disposed on the first electrode. The first dot pattern contact layer includes a plurality of discrete protrusions.

### CROSS-REFERENCE TO RELATED PATENT APPLICATIONS

The present application claims benefit of U.S. provisional application 60/929,161, filed Jun. 15, 2007, which is incorporated herein by reference in its entirety.

### BACKGROUND OF THE INVENTION

The present invention is generally directed to fuel cell components and more specifically to fuel cell stack interconnects.

Fuel cells are electrochemical devices which can convert energy stored in fuels to electrical energy with high efficiencies. High temperature fuel cells include solid oxide and molten carbonate fuel cells. These fuel cells may operate using hydrogen and/or hydrocarbon fuels. There are classes of fuel cells, such as the solid oxide reversible fuel cells, that also allow reversed operation, such that water or other oxidized fuel can be reduced to unoxidized fuel using electrical energy as an input.

Fuel cell stacks are frequently built from a multiplicity of cells in the form of planar elements, tubes, or other geometries. Fuel and air are provided to the electrochemically active surfaces of each cell's electrodes. A gas flow separator (referred to as a gas flow separator plate in a planar stack) separates the individual cells in the stack. The gas flow separator plate separates fuel, such as hydrogen or a hydrocarbon fuel, flowing to the fuel electrode (i.e., anode) of one cell in the stack from oxidant, such as air, flowing to the air electrode (i.e., cathode) of an adjacent cell in the stack. Frequently, the gas flow separator plate is also used as an interconnect which electrically connects the fuel electrode of one cell to the air electrode of the adjacent cell. In this case, the gas flow separator plate which functions as an interconnect is made of or contains an electrically conductive material.

The electrical contact between an electrode and an interconnect is enhanced by using a contact layer between the electrode and the interconnect. For example, an electrically conductive contact layer, such as a nickel contact layer, is provided between an anode electrode and an interconnect. A second contact layer is provided between a cathode electrode and an interconnect. The second contact layer optionally contains a material that matches the material contained in the cathode, such as lanthanum strontium manganite.

Interconnects are typically fabricated by machining a desired interconnect structure from stock material. The machining process, however, is a serial and expensive fabrication method. It is also difficult to consistently achieve the high tolerance levels required of the interconnect channels by machining. Contact layers are prepared as inks and are screen printed on the appropriate sides of the interconnect or electrode. Difficulty in registration between the contact layer and the machined features of the interconnect decreases both system performance and production yield.

### SUMMARY OF THE INVENTION

One aspect of the present invention provides a fuel cell system which includes a dot pattern contact layer located between an interconnect and an electrode of a fuel cell. The dot pattern contact layer is located either on the interconnect or on the electrode.

Another aspect of the present invention provides a fuel cell which includes a first electrode, a second electrode, an electrolyte, and a dot pattern contact layer disposed on the first electrode. The dot pattern contact layer includes a plurality of discrete protrusions.

### BRIEF DESCRIPTION OF THE DRAWINGS

FIGS. 1A-1C are schematic side cross-sectional views of dot pattern contact layers according to embodiments of the invention.

FIG. 1D is a schematic top view of a dot pattern contact layer according to an embodiment of the invention.

FIG. 2 is a schematic side cross-section view of a fuel cell system according to an embodiment of the invention.

### DETAILED DESCRIPTION OF THE PREFERRED EMBODIMENTS

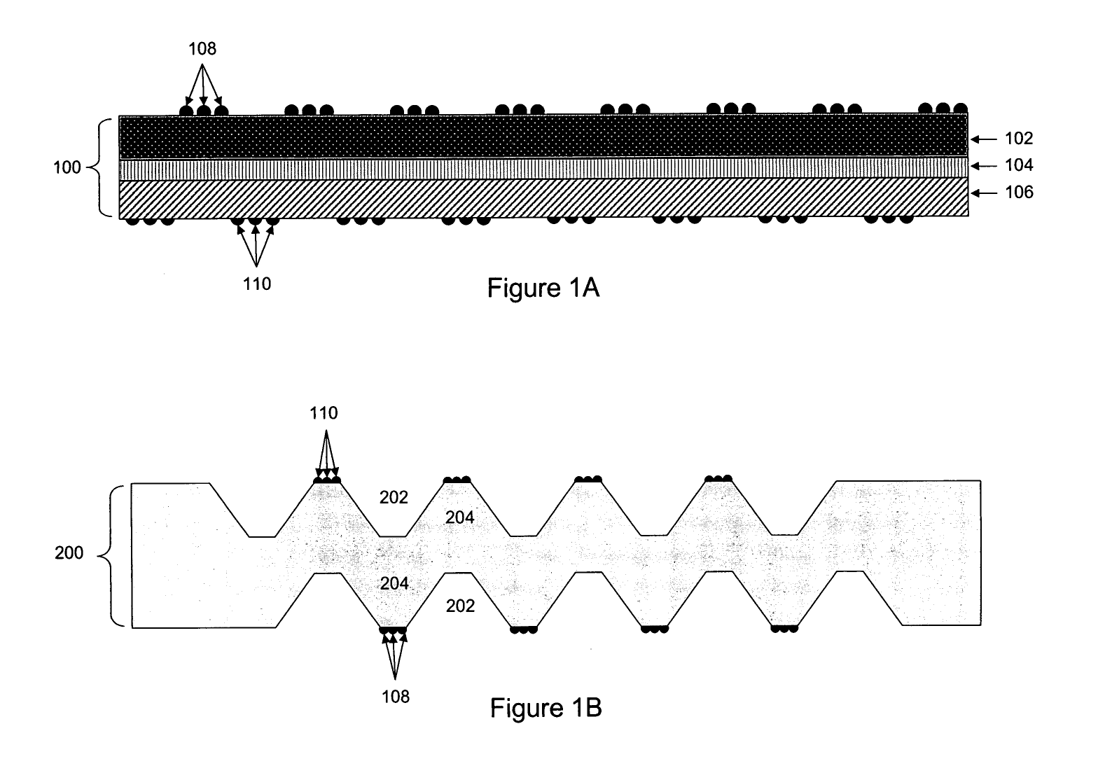

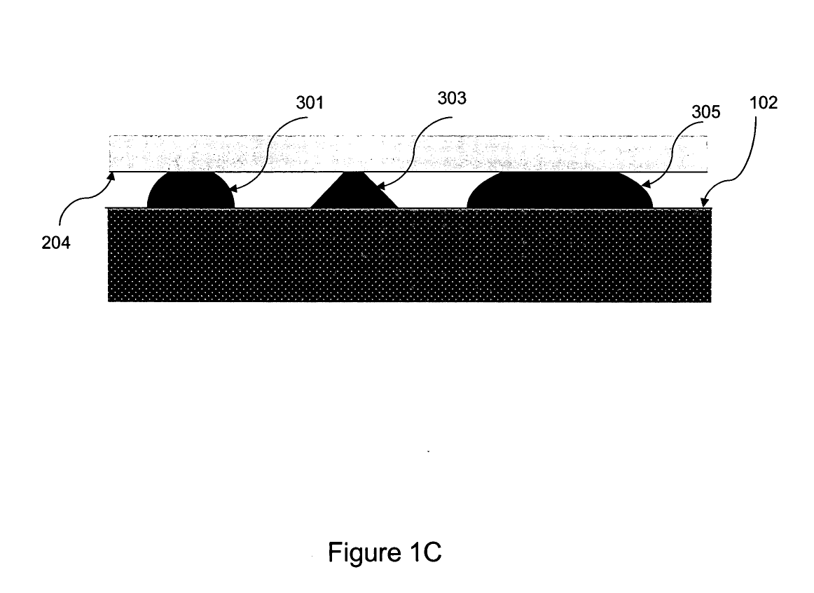

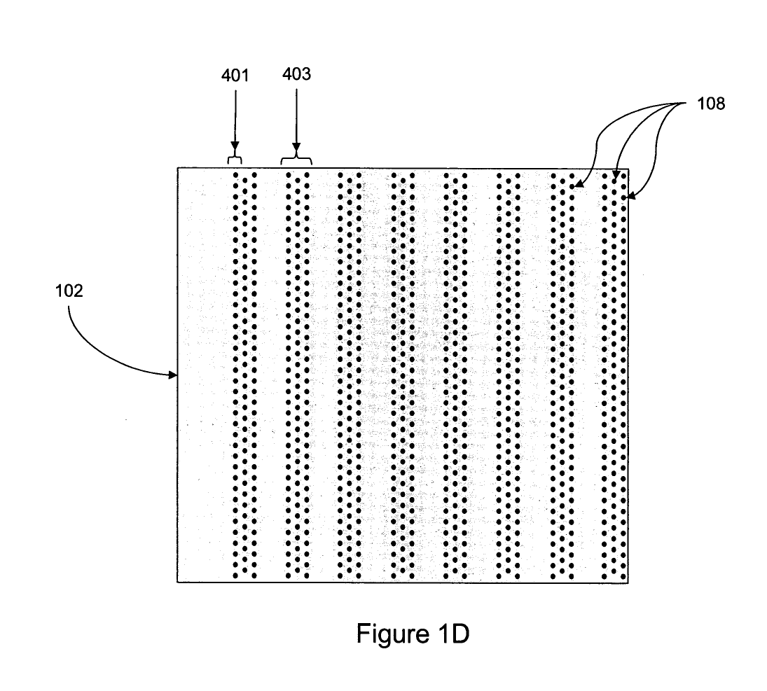

FIGS. 1A-1D illustrate dot pattern contact layers. In FIG. 1A, a fuel cell 100 contains a cathode electrode 102, an electrolyte 104, and an anode electrode 106. The cathode 102 contains a first dot pattern contact layer located on the top major surface of the cathode 102. The first contact layer includes a first plurality of discrete protrusions 108. The anode 106 contains a second dot pattern contact layer located on the bottom major surface of the anode 106. The second contact layer includes a second plurality of discrete protrusions 110. The protrusions are discrete solid dots that stand out in relief from the surface on which they are located. The height and areal density (i.e., dots per surface area) of the protrusions are independently controlled.

As depicted in FIG. 1A, the protrusions 108, 110 are located on opposite sides of the fuel cell 100. Optionally, the dot pattern contact layer is located on only one side of the fuel cell 100, and a conventional (i.e., flat and unitary) contact layer may be located on the other side or may be omitted. Each dot pattern contact layer may cover an entire side or a portion of a side. Preferably, the dot pattern contact layers cover only those portions of an electrode surface that will be contacted by an interconnect. For example, in the case of plate-shaped SOFCs and interconnects, where the interconnects contain a series of ribs disposed between a series of channels on the interconnect surfaces, a dot pattern contact layer is located only on the portions of the electrode where the ribs contact the electrode. In this way, contact print material is not wasted and the active surface area of the electrode is not blocked by contact print. The dot pattern contact layer increases the areal density of current-collection points for a given electrode. This helps to ensure that no point on the electrode is too far away from a current-collection point. At the same time, the dot pattern contact layer decreases the surface area of an electrode that is blocked by the contact print layer. This helps to maximize the active surface area of an electrode that is available for chemical reaction with gas stream species, thereby increasing the chemical efficiency of that electrode. Preferably, the areal density of the protrusions 108, 110 is sufficiently large to achieve high electrical conductivity between the electrode and interconnect, but is also sufficiently low to maximize the active area of the electrode available for reaction with gas stream species. The dot pattern contact layer also provides relaxed registration requirements (i.e., relaxed tolerances) between the electrode and the interconnect. Where contact layers are applied as a unitary line of contacting material, as opposed to as a dot pattern of discrete protrusions, precise registration between the contact layer and the rib tops of the interconnect is difficult to achieve.

The dot pattern contact layers are electrically conductive and are capable of forming an electrical contact between the interconnect and the electrode. Preferably, the materials contained in the protrusions 108, 110 match the electrical, chemical, thermal, and mechanical properties of the materials contained in the electrodes that are contacted by the respective protrusions. For example, the cathode 102 may comprise an electrically conductive material, such as an electrically conductive perovskite material, such as lanthanum strontium manganite (LSM). Other conductive perovskites, such as LSCo, etc., or metals, such as Pt, may also be used. The cathode 102 may also contain a ceramic phase similar to the anode. For example, the first plurality of protrusions 108, which are located on the cathode 102, comprise an electrically conductive perovskite material, such as LSM. The anode 106 may comprise a cermet comprising a nickel containing phase and a ceramic phase. The nickel containing phase preferably consists entirely of nickel in a reduced state. This phase forms nickel oxide when it is in an oxidized state. Thus, the anode electrode is preferably annealed in a reducing atmosphere prior to operation to reduce the nickel oxide to nickel. The nickel containing phase may include other metals in additional to nickel and/or nickel alloys. The ceramic phase may comprise a stabilized zirconia, such as yttria and/or scandia stabilized zirconia and/or a doped ceria, such as gadolinia, yttria and/or samaria doped ceria. For example, the second plurality of protrusions 110, which are located on the anode 106, comprise a nickel containing phase, such as NiO, which upon annealing is reduced to nickel. Due to the higher conductivity of the anode 106 materials compared to the cathode 102 materials, the first plurality of protrusions 108 located on the cathode 102 may be arranged more closely together (i.e., higher areal density) in order to improve current flow on the cathode 102 side.

FIG. 1B illustrates an interconnect 200 having a series of channels 202 disposed between a series of ribs 204. The channels 202 provide flow paths for a gas stream, and the ribs 204 provide electrical contacting between the electrodes of adjacent fuel cells. Preferably, the ribs on opposites sides of the interconnect 200 are laterally offset from each other across the interconnect 200 such that the thickness measured between the top and bottom surfaces of the interconnect 200 is as constant as possible. For example, the interconnect described in U.S. patent application Ser. No. 11/707,070, filed Feb. 16, 2007, which is incorporated herein by reference in its entirety, may be used.

As depicted in FIG. 1B, each major side of the interconnect 200 contains a dot pattern contact layer. Preferably, the dot pattern contact layers cover only those portions of the interconnect 200 that will contact an electrode. For example, the protrusions 108, 110 are located on the contacting surfaces of the ribs 204 of the interconnect 200 and not in the channels 202. However, if desired, the entire surface of the interconnect 200 may be covered with the dot pattern contact layer. The protrusions 110, which are located on the top surface of the interconnect 200 and which are adapted to contact the anode 106 of the cell 100, comprise a nickel containing phase, such as NiO, which upon annealing is reduced to nickel. The protrusions 108, which are located on the bottom surface of the interconnect 200 and which are adapted to contact the cathode 102 of the cell 100, comprises an electrically conductive perovskite material, such as LSM. Preferably, the dot pattern contact layer is compressible such that those individual protrusions which are located in areas where ribs are slightly taller (e.g., due to manufacturing imperfections) than other ribs can be compressed to allow other protrusions to achieve physical contact with the respective electrodes. For example, the protrusions are malleable or elastic. Thus, the dot pattern contact layer increases the production yield of the fuel cell manufacturing process by relaxing certain design tolerances of the interconnect and the contact layer. Thus, the dot pattern contact layer can be located either on the electrode or on the interconnect or both.

FIG. 1C represents a closer view of the protrusions of the dot pattern contact layer located on a first surface, such as on the cathode 102 surface. The protrusions can be formed in a variety of shapes and sizes. For example, the protrusions can have a hemispherical shape 301, a conical or pyramidal shape 303, or a hemiellipsoidal shape 305. Preferably, each protrusion is rigidly affixed to the surface 102 on which the droplet was deposited. When viewed in cross section, each protrusion contains a tip that is narrower than its base, and the base of each protrusion is located on the surface 102 on which the droplet was deposited. The tip of each protrusion is contacted by a second surface, such as the ribs 204 of the interconnect 200. When pressure is applied to the protrusions, the protrusions are compressed to accommodate variations in the relative distances between the first and second surfaces 102, 204. For example, small manufacturing defects are corrected by allowing those individual protrusions located on taller rib sections to be deformed, thereby allowing protrusions located on shorter rib sections to come into contact with the electrode. In contrast, conventional (i.e., flat and unitary) contact layers generally do not achieve such precise, localized defect correction because they are more difficult to compress than the protrusions, and would not allow the shorter rib sections to come into contact with the electrode. Preferably, substantially all of the protrusions of the dot pattern contact layer are in physical contact with both the first and second surfaces 102, 204. As used herein, the shapes 301, 303, 305 of the protrusions are hemispherical, conical or pyramidal, or hemiellipsoidal despite any deformation induced by compression. Alternatively, the protrusions may have a roughly cylindrical shape in which the tip is not narrower than the base, especially if the protrusions are transferred in the solid state.

FIG. 1D shows the top major surface of the cathode electrode 102 on which a dot pattern contact layer is located. The dot pattern contact layer is comprised of the first plurality of discrete protrusions 108. The dot pattern contact layer is located only on those portions of the cathode 102 that will be in physical contact with the ribs of an interconnect. In this case, the protrusions 108 are arranged into rows 401, and each row is aligned substantially parallel to the other rows 401 located on the cathode 102. The rows 106 can be uniformly spaced apart from each other and cover the entire surface, or can be grouped into sets 403 whose width is approximately equal to the width of the interconnect ribs to be contacted. Each set 403 contains at least two rows, such as two to seven rows. For example, the sets 403 shown in FIG. 1D contains three rows. Within each set 403, the plurality of discrete protrusions 108 can be arranged to achieve different nearest-neighbor distances between protrusions and/or different areal densities of protrusions. For example, the rows 401 can be aligned such that a protrusion has four nearest neighbors, or as shown in FIG. 1D the rows 401 can be offset such that a protrusion has six nearest neighbors. Other configurations can be used to achieve different current densities between the electrode and the interconnect.

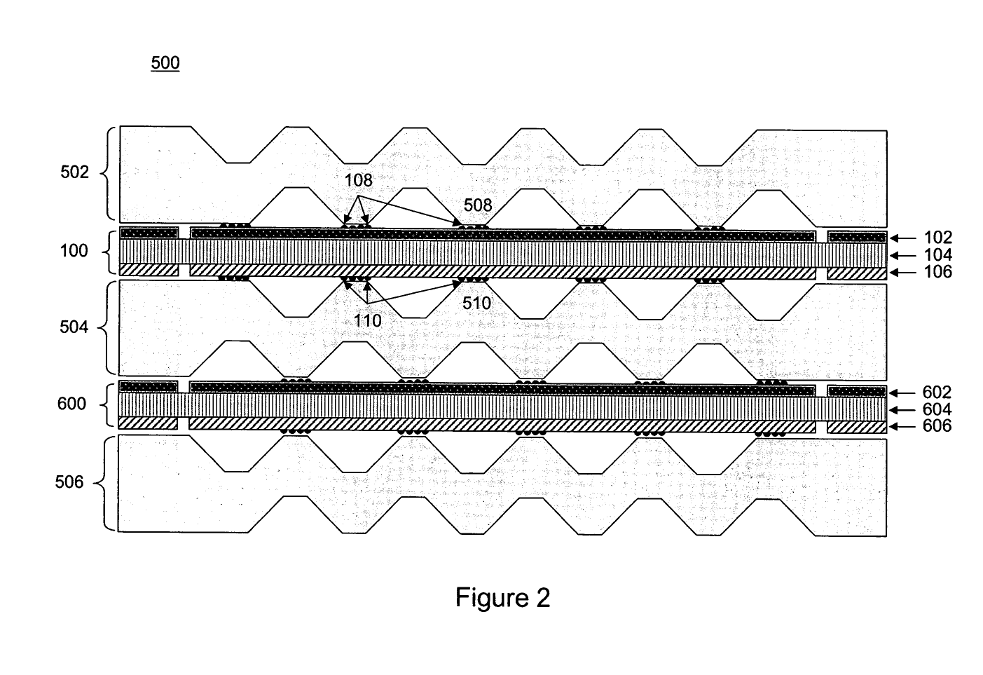

FIG. 2 illustrates a fuel cell stack 500 with alternating plate-shaped solid oxide fuel cells 100, 600 and interconnects 502, 504, 506. While a vertically oriented stack is shown in FIG. 2, the fuel cells and interconnects may be stacked horizontally or in any other suitable direction between vertical and horizontal. While solid oxide fuel cells are preferred, other fuel cell types, such as molten carbonate, PEM, phosphoric acid, etc., may also be used instead of SOFCs.

As shown in FIG. 2, each SOFC 100, 600 includes a cathode electrode 102, 602 a solid oxide electrolyte 104, 604 and an anode electrode 106, 606. The interconnects 502, 504, 506 separate the individual cells in the stack. The interconnects also separate fuel, such as a hydrogen and/or a hydrocarbon fuel, flowing to the fuel electrode (i.e. anode 106, 606) of one cell in the stack, from oxidant, such as air, flowing to the air electrode (i.e. cathode 102, 602) of an adjacent cell in the stack. As shown in FIG. 2, the interconnect 504 electrically connects the fuel electrode 106 of the first cell 100 to the air electrode 602 of the second cell 600. The interconnects are made of or contain electrically conductive material. The interconnect may be formed from a metal alloy, such as a chromium-iron alloy, or from an electrically conductive ceramic material, which optionally has a similar coefficient of thermal expansion to that of the electrolyte 104, 604.

The term “fuel cell stack,” as used herein, means a plurality of stacked fuel cells which share a common fuel inlet and exhaust passages or risers. The “fuel cell stack,” as used herein, includes a distinct electrical entity which contains two end plates which are connected to power conditioning equipment and the power (i.e., electricity) output of the stack. Thus, in some configurations, the electrical power output from such a distinct electrical entity may be separately controlled from other stacks. The term “fuel cell stack” as used herein, also includes a part of the distinct electrical entity. For example, plural stacks may share the same end plates. In this case, the stacks jointly comprise a distinct electrical entity.

To enhance the electrical contact between the SOFCs and the interconnects, an electrically conductive contact layer, such as a dot pattern contact layer made of nickel or other electrically conducting material, such LSM, is provided between the electrodes and the interconnects. The dot pattern contact layers are deposited, such as by using a screen printing process, either on the electrodes or on the interconnects. For example, each major side of the SOFC 100 contains a dot pattern contact layer comprised of a plurality of discrete protrusions 108, 110. The first plurality of protrusions 108 are in physical contact with the ribs 508 on the bottom surface of the interconnect 502. The second plurality of protrusions 110 are in physical contact with the ribs 510 on the top surface of the interconnect 504. Where small manufacturing defects render the contact incomplete or intermittent, a compressive force is applied to the SOFC 100 in order to partially deform the protrusions 108, 110 such that physical contact is achieved between substantially all of the protrusions 108, 110 and the interconnects 502, 504.

The dot pattern contact layer is deposited as droplets of ink on the electrodes 102, 106 using a screen printing process. Alternatively, the screen printing process is used to deposit the dot pattern contact layer on the ribs 508, 510 of the interconnects 502, 504. For example, the screen printing process includes depositing an ink through a stencil mask to generate the dot pattern arrangement. Alternative deposition methods include, but are not limited to, a liquid dispensation from a dispenser, an ink jet printing, solid sticker-like transfer, and stamp lithography. Each deposited droplet is not in physical contact with any other deposited droplet. The ink includes a liquid phase of the conductive material contained in the protrusions. Alternatively, the ink contains an aqueous suspension of solid particles of the conductive material of the protrusions. For example, the ink contains LSM or Ni. For example, the ink is a metallic nickel powder ink. The ink is solidified, for example by drying and/or cooling, to form the solid protrusions. For example, the ink is dried by firing the ink and the water contained in the ink is thereby evaporated. The droplets need not be solidified prior to stacking the interconnects 502, 504 and fuel cells 100, 600. For example, “wet” assembly involves stacking the interconnects 502, 504 and fuel cells 100, 600 into a fuel cell stack prior to the step of solidifying the protrusions 108, 110. Optionally, the screen printing process is performed as a batch process, such as on a moving substrate which passes through several deposition stations or chambers in a multichamber deposition apparatus. Alternatively, a stationary substrate may be used.

In another embodiment, the dot pattern contact layer includes a plurality of discrete, electrically conductive, three dimensional protrusions that are attached to either the fuel cell electrodes or to the interconnect, at least temporarily, by an adhesive. Each protrusion can have a three-dimensional shape of a “ball.” Preferably, these balls have a shape that is spherical or substantially spherical (e.g., having a small deviation from a perfect sphere). However, after the balls have been contacted (and optionally sintered) between the electrode and the interconnect, the balls can have a deformed spherical shape, such that the sphere is partially flattened on the top and the bottom and partially elongated on the sides. Other regular and irregular three dimensional protrusion shapes besides spheres, such as polyhedron shapes, may also be used. The size of these protrusions is preferably smaller than the width of a rib of the interconnect. For example, the diameter of a ball, prior to deformation, can be about 10 μm to about 1,000 μm, such as about 50 μm to about 500 μm, preferably about 75 μm to about 150 μm, for example about 100 μm. Preferably, the dot pattern contact layer is a single ball thick.

The balls can be made of any suitable material to provide electrical contact between the electrode and the interconnect. For example, the balls can be made of a metal or metal alloy, such as nickel for the anode side of the fuel cell and platinum for the cathode side of the fuel cell. Additionally, the balls can be hollow, which may increase their compliance, or the balls can be filled with a material that is different from its shell material. For example, the balls may be filled with a material, such as an organic material, which chemically or physically decomposes during high-temperature sintering and fuel cell operation. The material undergoing decomposition is removed from the balls through holes in the shell or through the shell surface, thus rendering the balls at least partially hollow, which may increase their compliance. The adhesive can be deposited on either the interconnect or the electrode, or both. The balls can be attached to the adhesive before or after the adhesive is provided onto the interconnect or the electrode. For example, the balls can be pre-mixed in the adhesive followed by depositing the adhesive containing embedded conductive balls on the interconnect or on the electrode. Alternatively, the adhesive layer is first applied to the interconnect or to the electrode, and then the balls are deposited on the adhesive by being pushed into or onto the adhesive layer or by flushing the adhesive layer with the conductive balls.

Any suitable adhesive can be used. The adhesive can be electrically conductive or non-conductive. For example, a high temperature adhesive can be chosen that survives high-temperature sintering and fuel cell operation, such that the adhesive remains present in the fuel cell stack during operation. Alternatively, a low-temperature adhesive can be used which chemically or physically decomposes (e.g., evaporates, oxidizes, undergoes pyrolization, or is otherwise unstable) during fuel cell stack sintering and operation. The balls are held in place by pressure between the electrode and the interconnect after the low temperature adhesive evaporates. After the adhesive and balls are deposited, the dot pattern contact layer is sandwiched between the interconnect and the electrode. During sintering and conditioning of the fuel cell, the high local pressure may cause deformation of the balls between the interconnect and the electrode. This deformation can be elastic or plastic, or both. Preferably, the balls are sufficiently deformed to provide compliance and electrical contact through substantially all of the balls of the dot pattern contact layer.

The foregoing description of the invention has been presented for purposes of illustration and description. It is not intended to be exhaustive or to limit the invention to the precise form disclosed, and modifications and variations are possible in light of the above teachings or may be acquired from practice of the invention. The description was chosen in order to explain the principles of the invention and its practical application. It is intended that the scope of the invention be defined by the claims appended hereto, and their equivalents.

What is claimed is:

1. A fuel cell system, comprising:
a fuel cell comprising first and second electrodes and an electrolyte;
a first interconnect; and
an electrically conductive first dot pattern contact layer located between the first electrode and the first interconnect.

2. The system of claim 1, wherein the first dot pattern contact layer is located on the first electrode and contacts the first interconnect.

3. The system of claim 2, wherein:
the first interconnect comprises a series of channels disposed between a series of ribs;
the first dot pattern contact layer comprises a plurality of discrete protrusions; and
the protrusions comprise a three-dimensional shape having a size smaller than the width of a rib of the interconnect.

4. The system of claim 1, wherein the first dot pattern contact layer is located on the first interconnect and contacts the first electrode.

5. The system of claim 4, wherein:
the first interconnect comprises a series of channels disposed between a series of ribs;
the first dot pattern contact layer comprises a plurality of discrete protrusions; and
the protrusions comprise a three-dimensional shape having a size smaller than the width of a rib of the interconnect.

6. The system of claim 1, further comprising a second interconnect and a second dot pattern contact layer, wherein the second dot pattern contact layer is located between the second electrode and the second interconnect.

7. The system of claim 6, wherein:
the first electrode comprises a cathode comprising an electrically conductive perovskite material;
the second electrode comprises an anode comprising nickel;
the first dot pattern contact layer comprises the electrically conductive perovskite material; and
the second dot pattern contact layer comprises nickel.

8. The system of claim 7, wherein the perovskite material comprises lanthanum strontium manganite.

9. They system of claim 1, wherein:
the first dot pattern contact layer comprises a plurality of discrete protrusions; and
each protrusion comprises a shape having a tip that is narrower than a base.

10. The system of claim 9, wherein:
each base is located on the first electrode; and
each tip contacts the first interconnect.

11. The system of claim 9, wherein:
each base is located on the first interconnect; and
each tip contacts the first electrode.

12. The system of claim 1, wherein the first dot pattern contact layer comprises a plurality of balls having a substantially spherical or deformed spherical shape having a size smaller than a width of a rib of the interconnect.

13. The system of claim 12, wherein the first electrode comprises an anode and the balls comprise nickel.

14. The system of claim 13, wherein the balls have a diameter of about 50 μm to about 200 μm.

15. A fuel cell, comprising:
a first electrode;
a second electrode;
an electrolyte; and
an electrically conductive first dot pattern contact layer disposed on the first electrode.

16. The cell of claim 15, wherein:
the first electrode is adapted to electrically contact a fuel cell interconnect; and
the first dot pattern contact layer comprises a plurality of discrete protrusions having a three-dimensional shape with a size smaller than the width of a rib of the interconnect.

17. The cell of claim 16, wherein:
each protrusion comprises a shape having a tip that is narrower than a base; and
each base is disposed on the first electrode.

18. The cell of claim 16, wherein:
the first electrode comprises a cathode comprising an electrically conductive perovskite material; and
the first dot pattern contact layer comprises the electrically conductive perovskite material.

19. The cell of claim 18, wherein the perovskite material comprises lanthanum strontium manganite.

20. The cell of claim 16, wherein:
the first electrode comprises an anode comprising nickel; and
the first dot pattern contact layer comprises nickel.

21. The cell of claim 16, further comprising a second dot pattern contact layer disposed on the second electrode, wherein:
the first electrode comprises a cathode comprising an electrically conductive perovskite material;
the second electrode comprises an anode comprising nickel;
the first dot pattern contact layer comprises the electrically conductive perovskite material; and
the second dot pattern contact layer comprises nickel.

22. The cell of claim 16, wherein:
the plurality of discrete protrusions comprise parallel rows of protrusions; and
the parallel rows are aligned such that substantially of all of protrusions are adapted to physically contact an interconnect comprising a series of channels disposed between a series of ribs.

23. The cell of claim 15, wherein the first dot pattern contact layer comprises a plurality of balls having a substantially spherical or deformed spherical shape.

24. The cell of claim 23, where the first electrode comprises an anode and the balls comprise nickel and have a diameter of about 50 μm to about 200 μm.

25. A method of making a dot pattern contact layer, comprising:
providing a first ink onto at least one of a first fuel cell electrode or a fuel cell interconnect; and
solidifying the first ink to form a first plurality of discrete protrusions;
wherein:
the first ink comprises a first material that is capable of forming an electrical contact between the interconnect and the first electrode.

26. The method of claim 25, wherein:
the step of providing a first ink comprises depositing droplets of the first ink using a screen printing process such that each deposited droplet is not in physical contact with any other deposited droplet; and
the step of solidifying the first ink comprises at least one of drying or cooling the deposited droplets.

27. The method of claim 26, further comprising:
providing a second ink onto a second fuel cell electrode;
solidifying the second ink to form a second plurality of discrete protrusions; and
placing the fuel cell interconnect in contact with at least one of the first or second pluralities of discrete protrusions;
wherein:
the step of providing the first ink comprises providing the first ink onto the first fuel cell electrode; and
the first and second pluralities of discrete protrusions are located on opposite sides of a fuel cell.

28. The method of claim 26, further comprising:
providing a second ink onto the interconnect;
solidifying the second ink to form a second plurality of discrete protrusions; and
placing the fuel cell electrode in contact with the interconnect;
wherein:
the step of providing the first ink comprises providing the first ink onto the interconnect;
the interconnect comprises two opposite major surfaces each comprising a series of channels disposed between a series of ribs; and
the first and second pluralities of discrete protrusions are located on the ribs of the two opposite major surfaces.

29. The method of claim 25, wherein the dot pattern contact layer electrically connects the first fuel cell electrode to the interconnect.

30. The method of claim 25, wherein the step of solidifying occurs after the fuel cell electrode or the fuel cell interconnect are provided into a fuel cell stack.

31. A method of making a dot pattern contact layer, comprising:
providing an adhesive and a plurality of discrete, electrically conductive protrusions onto at least one of a fuel cell electrode or a fuel cell interconnect; and
contacting the protrusions such that at least a portion of the protrusions are in physical contact with the fuel cell electrode and the fuel cell interconnect and form an electrical contact between the interconnect and the fuel cell electrode.

32. The method of claim 31, wherein:
the step of providing the adhesive and the plurality of discrete, electrically conductive protrusions comprises providing an adhesive layer onto ribs of the interconnect and providing the protrusions onto the adhesive layer; and
the step of contacting comprises placing the fuel cell electrode onto the protrusions to at least partially deform the protrusions.

33. The method of claim 32, wherein:
the fuel cell electrode comprises an anode and the discrete protrusions comprise nickel balls having a spherical or a substantially spherical shape;
prior to the step of contacting, the balls comprise a diameter that is smaller than a width of a rib of the interconnect; and
after the step of contacting, the balls have a deformed spherical shape.

34. The method of claim 31, wherein a diameter of the balls is about 50 μm to about 200 μm.

35. The method of claim 31, further comprising sintering the fuel cell to chemically or physically decompose the adhesive after the step of contacting.

36. The method of claim 31, wherein the step of providing the adhesive and the plurality of discrete, electrically conductive protrusions comprises providing a plurality of electrically conductive balls embedded in an adhesive layer onto ribs of the interconnect or onto the electrode of the fuel cell.
